(19) United States
(12) Patent Application Publication
(10) Pub. No.: US 2003/0162537 A1
(43) Pub. Date: Aug. 28, 2003

(54) Update of producer-specific hardware information on the producer-independent omc-nmc interface in a mobile radio network

(76) Inventor: Lucian Hirsch, Munchen (DE)

Correspondence Address: MORRISON & FOERSTER LLP, 1650 TYSONS BOULEVARD, SUITE 300, MCLEAN, VA, 22102, US

(21) Appl. No.: 10/275,306

(22) PCT Filed: Apr. 23, 2001
(86) PCT No.: PCT/EP01/04575

(30) Foreign Application Priority Data
May 4, 2000 (EP) 00109561.1

(51) Int. Cl. H04Q 7/20

(52) U.S. Cl. 455/423; 455/422

(57) ABSTRACT

The invention relates to a method and to communications system devices for updating information in an object-oriented, hierarchical communications system with at least two administrative levels via a producer-independent interface between a producer-independent managing device (NMC) and at least one agent device (OMC) that acquires and processes in a first condition producer-specific hardware information for the purpose of fault administration. The aim of the invention is to provide a method which allows for the processing of fault information at intervals when agent devices do not carry out such tasks. To this end, producer-specific hardware information is transmitted via the interface in a producer-independent format to the managing device (NMC). This transmission can proceed especially within a new producer-independent object class (equipment info) that is defined for retrieving an equipment information via the interface that contains as the information elements an action request (scanEquipment) of the managing device (NMC) to the agent device (OMC) to request the transfer of the hardware information, and an attribute value change transfer for the element condition (boardStatus).

The invention relates to a method for updating proprietary hardware information at the nonproprietary OMC/NMC interface in a mobile radio network in accordance with the precharacterizing features of claim 1 and to a communications system comprising corresponding devices for carrying out the method.

In a typical communications system—for example a mobile communications system—the principles of a management network, also called TMN (Telecommunications Management Network) principles, define a number of management levels for managing the communications system, each level having a dual function, i.e. each level, apart from the lowermost one, having a manager function for the level underneath and each level, apart from the topmost one, having an agent function for the next higher level.

Fault management is an important part of the TMN management. In this case, as a rule, the agent plays the active role in that it detects fault events of its own management level in time and accurately and transmits these as so-called event reports (e.g. alarm reports) to the manager of the next higher level. It is particularly when a reported fault cannot be dealt with by the receiving manager station itself, that the latter forwards this fault message or a suitably modified fault message to the next higher level. The transmission of event data from the respective agent to the manager is not critical as long as the processing is possible at a receiving level and/or the communication mechanism between this level and the next higher level functions so that the reported fault is forwarded to this next higher level which can process it.

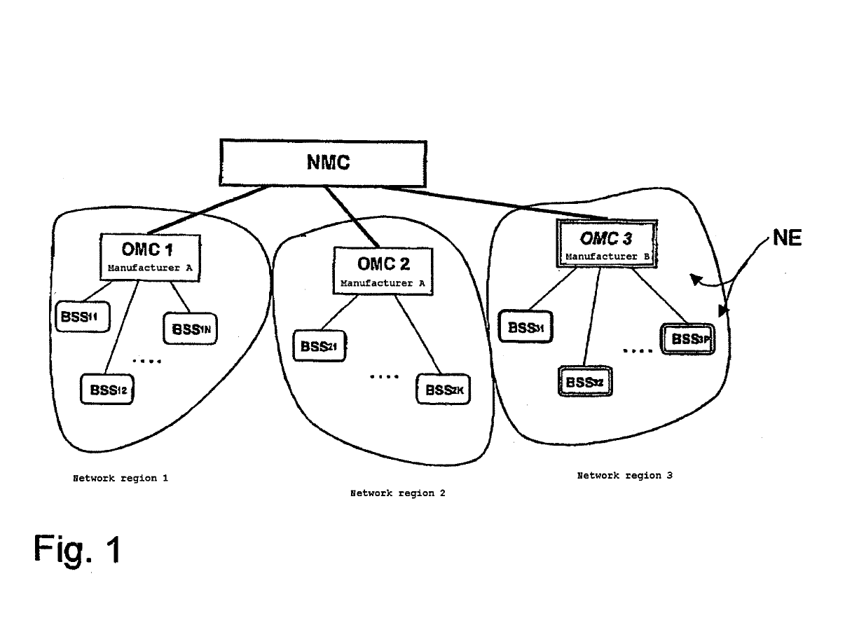

From the operational point of view, a complete telecommunications network managed by a service provider such as, e.g. a GSM mobile radio network, is subdivided into a number of network regions as can be seen from FIG. 1. The network regions comprise, among other things, element managers, particularly the operation and maintenance centers OMCs which, as a rule, administer a multiplicity of base station subsystems BSSᵢⱼ. A multiplicity of network regions belonging to a network is administered by a joint so-called network management center NMC. The administration is effected via in each case one interface between the network management center NMC and the element managers OMC of the individual network regions.

Although the entire network can contain hardware from different manufacturers, both the network elements and the element managers OMCs in each network region are supplied by the same manufacturer since the management at the element manager OMC must take into consideration all proprietary characteristics of the hardware, i.e. also the associated tests for checking the faultless operation of the network elements.

Therefore, the interface between network management center NMC and the regional element managers OMCs must be nonproprietary in order to provide for a functional integration of proprietary network regions under one uniform network management center NMC. This manufacturer-independence of the OMC/NMC interface can be achieved by using logical, in this case function-related management object classes (MOCs) in an object-oriented management environment. The functional objects model the network resources of a telecommunications network from a functional, nonproprietary point of view.

In contrast, the proprietary interface between OMC and the network elements NE also knows so-called equipment-related management object classes (MOCs) which differ from manufacturer to manufacturer.

In the peak traffic hours, fault monitoring usually takes place in the element managers OMCs. During the night, on holidays and on weekends, however, the mobile radio network described here by way of example is monitored by the higher-level network management center NMC since the regional OMCs are then unoccupied.

For this reason, optimum network management at the network management center NMC according to the TMN hierarchy at the network management level would presuppose that there must also be information about the hardware at the NMC. This information should:

a) enable the NMC operator to detect the real cause of a fault after the failure of hardware components, particularly equipment boards which is of particular importance when the regional element managers OMC are unoccupied and the mobile radio network is only monitored from the network management center NMC, and

b) enable the NMC system to create accurate fault descriptions or “trouble tickets” in order to initiate corresponding local repair measures.

There is an apparent conflict here: on the one hand, the OMC/NMC interface must be nonproprietary, but, on the other hand, proprietary information is needed at the network management center NMC.

A first nonproprietary approach for providing hardware information at the OMC/NMC interface is the definition of generic equipment summary MOCs, e.g. btsEquipment, bscEquipment, transcoderEquipment (bts: base transceiver station, bsc: base station controller) which model the entire hardware of a network unit. However, such an approach has the disadvantage that with each introduction of new network unit types, in order to introduce, e.g. new functions into a mobile radio network, the object model of the OMC/NMC interface must be extended and the application software must be changed both in the agent (OMC) and in the manager (NMC).

An object is generally produced as a result of a modeling activity in which, apart from the functions, among other things, the parameters and boundary conditions are defined and it is known both to the manager and to the executive agent at the corresponding interface, in this case, e.g. in the case of a mobile radio network, at the interface between an operation and maintenance center OMC and a network management center NMC.

The invention is based on the object of providing a method for updating proprietary hardware information at the multi-vendor or nonproprietary OMC/NMC interface in a mobile radio network or, respectively, a communications system having corresponding facilities for carrying out the method, in which the OMC/NMC interface, on the one hand, is nonproprietary but, on the other hand, proprietary information is made available at the network management center NMC.

This object is achieved by the method having the features of claim 1 and the communications system having the features of claim 10.

Advantageous developments are the subject matter of subclaims.

Using the method for updating information, proprietary hardware information is transferred in a nonproprietary format via the interface to the manager device.

A nonproprietary object class for procuring equipment information via the interface can be defined in a particularly simple manner if it exhibits as information elements an action request by the manager device to the agent device for requesting the transmission of the hardware information and an attribute value change notification for the element condition. Using just these few information items, it is possible to monitor subordinate management levels with network elements from different manufacturers.

The transmission of attribute value changes makes it possible to model an instantaneous operability of a hardware network element, an insertion, a removal and/or a fault state of a hardware network element (NE) and it is advantageously also possible to transmit an operability state before a fault.

During the transmission of an attribute value change, it is also possible to transmit special information about a network element so that the transmission of these additional data can also be hardware-independent.

In particular, this also provides for fault management at times at which the agent devices cannot handle this.

Attribute values can be advantageously transmitted automatically on request by the manager device or, e.g. in the case of relevant state changes, from the agent device.

In particular, it is possible to transmit information not only about states in the agent unit but also about states in other network elements which, in turn, form subagent units or their other subunits with respect to the agent unit.

In summary, hardware information can be provided in a nonproprietary format to the higher-level network management center in a mobile radio network which consists of physical components from different manufacturers.

New network element types or new types of equipment boards can be introduced at any time in a mobile radio network in order to, e.g. support new functions such as the general packet radio service (GPRS) in the mobile radio network without requiring changes in the operation and maintenance center OMC or network management center NMC. In particular, the method is suitable for GSM and UMTS systems but can also be used in other, particularly future telecommunications systems and mobile radio systems.In

In the text which follows, an exemplary embodiment is explained in greater detail with reference to the drawing, in which:

FIG. 1 diagrammatically shows a part of a telecommunications system,

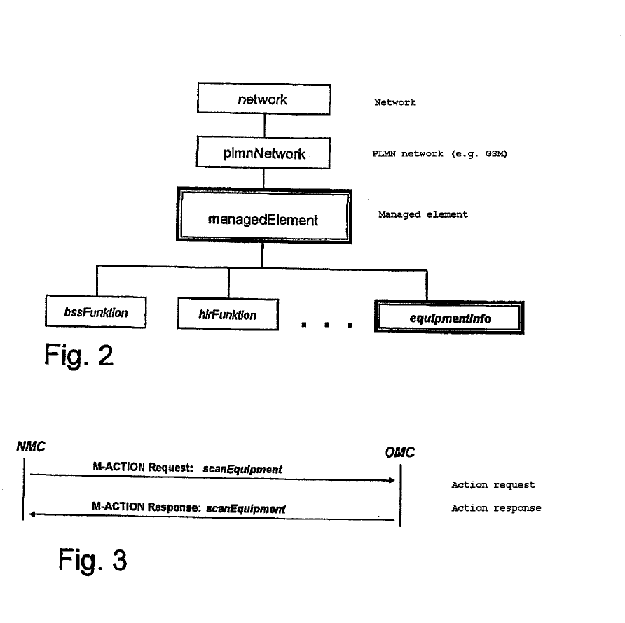

FIG. 2 shows a configuration of a containment tree according to the exemplary embodiment described,

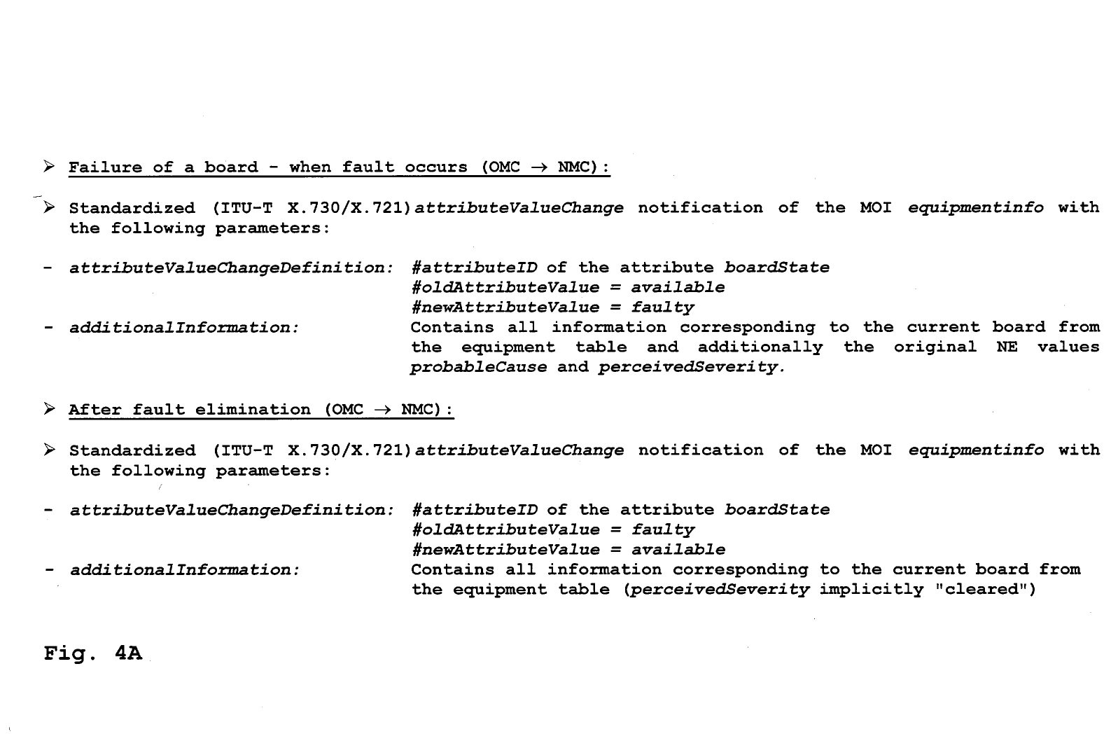

FIG. 3 diagrammatically shows the sequence of the main method steps, and

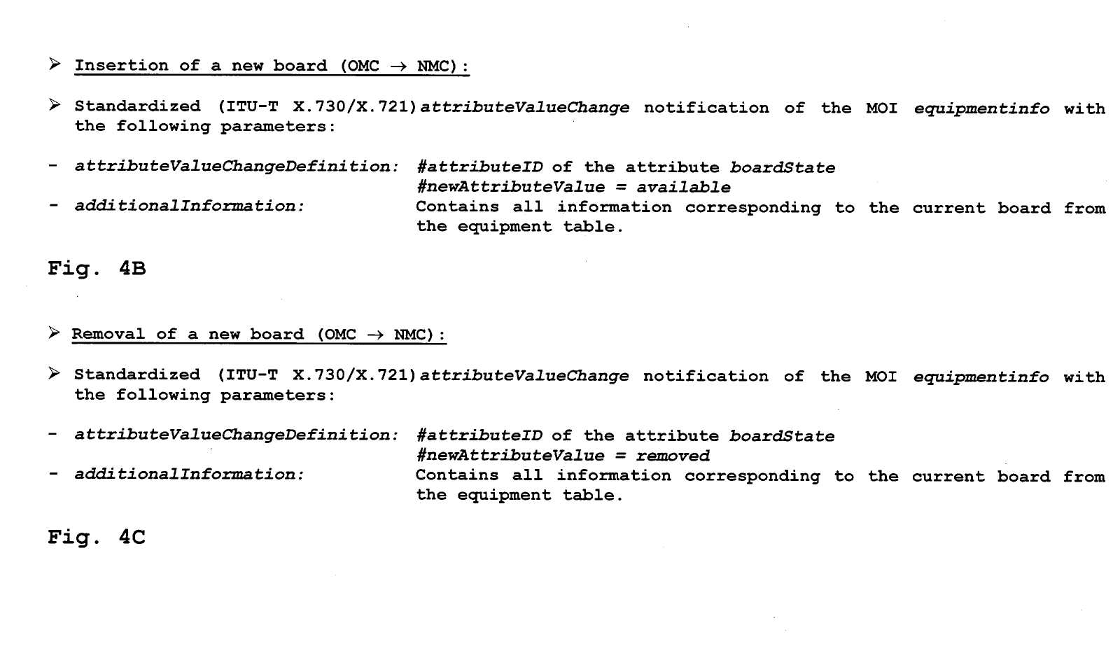

FIG. 4 shows information blocks for three situations in a managed network.

The exemplary embodiment describes the invention with reference to an exemplary TMN (Telecommunications Management Network) concept for the management of a mobile communications system which, for example, has network devices of a mobile radio network according to the GSM (Global System for Mobile communication) standard. However, the concept is not restricted to mobile radio networks according to, in particular, the GSM or UMTS (Universal Mobile Telecommunication System) standard but can be applied to other systems, particularly telecommunication networks of any type which exhibit a manager-agent relationship.

A mobile communications system is a hierarchically structured system of different network devices in which the lowest hierarchy level is formed by the mobile stations. These mobile stations communicate via a radio interface with radio stations which form the next hierarchy level and are called base stations. For example, base stations which cover mobile stations in a radio zone are combined to cover a relatively large radio area and are connected to higher-level network devices, the base station controllers. The base stations and base station controllers belong to a base station subsystem BSS of the mobile communications system. The base station controllers communicate with one or more switching devices, the mobile switching centers via which, among other things, the handover to other communication networks is effected via defined interfaces. The mobile switching centers, together with a multiplicity of databases, form the switching subsystem of the mobile communications system.

In addition to the above network devices, there are one or more operation and maintenance centers OMC which, among other things, are used for configuring and monitoring the network devices. For this purpose, monitoring measures and configuration measures are in most cases controlled remotely by one of the operation and maintenance centers OMC which are usually arranged in the area of the mobile switching centers and have the function of element managers. In this arrangement, an operation and maintenance center OMC in each case communicates with a base station subsystem BSS or switching system via a defined interface. Another task of the operation and maintenance system OMC is the performance of configuration management which, apart from fault management, represents one of five management disciplines currently identified by the TMN principles. The configuration management defines a number of services which enable the structure to be changed and thus the behavior of a telecommunication network to be changed by the operator. These services are usually related to classes and entities of managed objects which, together, form the network-specific management information base.

A managed object in the sense of configuration management is a logical abstraction of a resource in the mobile communications system. A distinction is made here between equipment-related managed objects which describe a proprietary implementation of a function and function-related managed objects which are in each case an abstraction of a nonproprietary function.

The method described hereinafter provides for the updating of, in particular, proprietary hardware information at the network management center NMC without using equipment-related object classes. The method allows the network management center NMC to receive or to interrogate hardware information in a nonproprietary and network-element-independent format via services.

For the communication between higher levels, a so-called high-level containment tree is defined which represents the higher management levels of a public land mobile network (PLMN) as described with reference to FIG. 2 in the text which follows.

For the object-oriented modeling of the OMC/NMC interface, the object class managedElement is of significance which can contain both function-related and equipment-related object classes.

In the present exemplary embodiment, an object class “equipmentInfo” is defined which contains the following information elements:

a) an action “scanEquipment” which models a request of the network management center NMC to the operation and maintenance center OMC for transmitting the equipment information, and

b) an attribute element state or board state which—as explained hereinafter—models the insertion/removal or the fault state of a hardware element or board in a network. The attribute can preferably assume the values available, faulty or removed.

A single equipmentInfo entity is advantageously sufficient for each network region.

The operation and maintenance center OMC administers an equipment table for all unit elements or boards from its management region where, in particular, an entry containing the following data is provided for each board:

a) NEy-type: specifies the type of network unit for which the information is called up or reported. Possible values e.g. for GSM networks are: btsEquipment, bscEquipment and transcoderEquipment.

b) NEy instance: specifies the instance number of the network unit in a network region, e.g. 7.

c) Rack No.: specifies the rack number within the current network unit, e.g. 1.

d) Board code: specifies the stock code of the board affected, e.g. S5-13579.

e) Board name: specifies the name of the unit affected as a character string, e.g. “BBSIG”.

f) Board number: specifies the board number in the current rack, e.g. 3.

g) RedundantInfo: specifies whether the current board or the unit affected is redundant or not. In the case of a redundant unit, immediate fault finding may not be required.

h) Board functions: describes the functions of the current board or of the unit affected, e.g. in the form of a character string.

The method for updating the equipment information at the network management center NMC suitably consists of two components:

A. A network management center synchronization after the setting-up of the OMC/NMC connection.

For the NMC synchronization of the network management center, illustrated in FIG. 3, the network management center NMC sends to each regional operation and maintenance center OMC, every time an OMC/NMC connection has been set up, an M-ACTION request scanEquipment which is associated with an M-ACTION response. These are standardized generic CMISE (Common Management Information Service Element) procedures.

The operation and maintenance center OMC forms from its own table of equipment boards the parameter “Action reply” of the M-ACTION response as a sequence of single entries having the previously defined structure (see components a) to h) above) and sends these to the network management center NMC.

Even if new NEy or board types were introduced, e.g. during the failure of the OMC/NMC connection, no change in the NMC application is required.

B. A permanent network management center (NMC) updating during the period of an OMC/NMC connection. In FIG. 4, information blocks for three situations in a managed network are outlined.

B1. In the case of the failure of an equipment board, the network management center NMC is informed about the fault state of each equipment board as follows (FIG. 4A).

If a fault occurs in a network unit NEy, the operation and maintenance center OMC, sends a standardized “attributeValueChangeNotification” of the management object instance MOI “equipmentinfo” with the following parameters:

“attributeValueChangeDefinition” with the identification number (#attributeID) of the attribute boardState with the old value of the attribute which is set to available (#oldAttributeValue=available), with the new value of the attribute which is set to faulty (#newAttributeValue=faulty), and

additionalInformation which contains all information relating to the current board from the equipment table and additionally the original network element values “probableCause” and “perceivedSeverity”.

When the fault in the network element NE is eliminated again, the operation and maintenance center OMC also sends an “attributeValueChangeNotification” of the management object instance MOI “equipmentInfo”, then with the parameters:

“attributeValueChangeDefinition” with the identification number (#attributeID) of the attribute board state, with the value of the old attribute which is set to faulty (#oldAttributeValue=faulty), with the new value of the attribute which is set to available (#newAttributeValue=available), and

additionalInformation which again contains all information corresponding to the current board from the equipment table. The field perceivedSeverity is set to “cleared”.

B2. In the case where a newly used equipment board is inserted (FIG. 4B), the operation and maintenance center OMC sends to the network management center NMC a standardized “attributeValueChangeNotification” of the management object instance MOI “equipmentInfo” with the following parameters:

“attributeValueChangeDefinition” with the identification number (#attributeID) of the attribute board state, with the new value of the attribute which is set to available (#newAttributeValue=available), and

additionalInformation which again contains all information corresponding to the current board from the equipment table.

The optional field for the old value of the attribute “oldAttributeValue” does not need to be used in this case.

B3. If an inserted equipment board is removed (FIG. 4C), the operation and maintenance center OMC sends to the network management center NMC a standardized “attributeValueChangeNotification” of the management object instance MOI “equipmentInfo” with the following parameters:

“attributeValueChangeDefinition” with the identification number (#attributeID) of the attribute board state, with the new value of the attribute which is set to removed (#newAttributeValue=removed), and

again, additionalInformation which again contains all information relating to the current board from the equipment table.

The optional field for the old value of the attribute “oldAttributeValue” does not need to be used in this case, either.

1. A method for updating information in an object-oriented, hierarchically structured communications system comprising at least two management levels via a nonproprietary interface between a nonproprietary manager device (NMC) and at least one agent device (OMC) which obtains proprietary equipment information and processes this information in a first state, characterized in that proprietary hardware information is transmitted in a nonproprietary format via the interface to the manager device (NMC).

2. The method as claimed in claim 1, in which a generic nonproprietary object class (equipmentInfo) for procuring equipment information via the interface is defined which exhibits as information elements
an action request (scanEquipment) of the manager device (NMC) to the agent device (OMC) for requesting the transmission of the hardware information, and
an attribute value change transmission for the element state (boardState).

3. The method as claimed in claim 2, in which the agent device, after the action request, determines the state of all boards of a network unit (NEy) in its area and provides it for the action response.

4. The method as claimed in claim 2, in which the attribute value change transmission models an instantaneous operability, an insertion, a removal and/or a fault states of a hardware network element (NE).

5. The method as claimed in one of claims 2 or 4, in which the attribute value change transmission models an operability state of a fault of a hardware network element (NE).

6. The method as claimed in one of claims 2, 4 or 5, in which special information about a network unit is transmitted in a nonproprietary format (additionalInformation) during the attribute value change transmission.

7. The method as claimed in one of the preceding claims, in which the attribute value change transmission from the agent device (OMC) is automatic in the case of relevant state changes.

8. The method as claimed in one of the preceding claims, in which the transmission via the interface is network element-independent.

9. The method as claimed in one of the preceding claims, in which proprietary hardware information about agent units (BSS) of the agent unit (OMC) is transmitted via the interface to the manager device (NMC).

10. A communications system, particularly comprising devices for carrying out a method according to one of the preceding claims, which exhibits
at least two object-oriented, hierarchically structured administration levels with a nonproprietary manager device (NMC) and at least one agent device (OMC) which obtains proprietary equipment information and processes it in a first state, and
a nonproprietary interface between these, characterized by an exchange device in the nonproprietary manager device (NMC) and the agent device(s) (OMC) for exchanging proprietary hardware information.

11. The communications system as claimed in claim 10, in which the interface is a nonproprietary interface between a network management center (NMC) and at least one operation and maintenance center (OMC) of a radio communication network.
